(19) United States
(12) Patent Application Publication
(10) Pub. No.: US 2026/0154231 A1
(43) Pub. Date: Jun. 4, 2026

(54) COMPUTING TASK MANAGEMENT METHOD FOR DATABASE, AND APPARATUS, ELECTRONIC DEVICE, STORAGE MEDIUM, SYSTEM AND COMPUTER PROGRAM PRODUCT THEREOF

(71) Applicant: SAMSUNG ELECTRONICS CO., LTD., Suwon-si (KR)

(72) Inventors: Cunbao CHANG, Suwon-si (KR); Hao Yan, Suwon-si (KR); Lijuan Xue, Suwon-si (KR); Wenbin Cao, Suwon-si (KR)

(73) Assignee: SAMSUNG ELECTRONICS CO., LTD., Suwon-si (KR)

(21) Appl. No.: 19/398,649

(22) Filed: Nov. 24, 2025

(30) Foreign Application Priority Data
Dec. 2, 2024 (CN) 202411754978.7

(51) Int. Cl. G06F 15/78; G06F 16/174

(52) U.S. Cl. CPC G06F 15/7821; G06F 16/1744

(57) ABSTRACT

The present disclosure provides a computing task management method, an apparatus, and a system, which are applied to a process near memory device. The method may include: based on receiving an execution instruction associated with a preset computing task from a host, acquiring, from a storage of the host, data associated with execution of the preset computing task, wherein the preset computing task is a computing task that, when performed by the host, includes data exchange between the storage and a CPU with a frequency higher than a preset degree and configured for computing power lower than a preset computing power; storing the data in a memory associated with the PNM device; obtain a computing result corresponding to the preset computing task based on performing the preset computing task using data exchange performed with the memory associated with the PNM device; and transmitting the computing result to the host.

### CROSS-REFERENCE TO RELATED APPLICATION

This application claims priority from Chinese Patent Application No. 202411754978.7, filed on Dec. 2, 2024 in Chinese Patent Office, and all the benefits accruing therefrom under 35 U.S.C. 119, the contents of which in its entirety are herein incorporated by reference.

### BACKGROUND

The present disclosure relates to a storage field, and specifically to a computing task management method for a database, and an apparatus, an electric device, a storage medium, a system and a computer program product thereof.

Some databases, e.g., RocksDB, are a Key-Value (KV) storage engine database, which have the following key features: (1) it uses a Log-Structured Merge (LSM) tree structure to store data; (2) it is an embedded persistent storage system and supports high throughput input/output (IO) reads and writes; and (3) there are a large number of computations in a storage process. These computations require data interaction between a central processing unit (CPU) and a memory.

In a Read/Write (R/W) process of such databases, there are many scenarios of massive data movement and simple computations where a large number of data replication between the memory and the CPU may occur, which is time-consuming and consumes a lot of CPU resources. Researchers have made a lot of efforts to improve the performance of such databases, but they only consider internal details, and there is no macroscopic architectural solution to solve the above problem.

### SUMMARY

Exemplary embodiments of the present disclosure provide a computing task management method for a database, and an apparatus, an electric device, a storage medium, a system and a computer program product thereof, to at least solve the above technical problem and other technical problem not mentioned above.

According to an aspect of the present disclosure, a computing task management method is provided. The method is applied to a process near memory device and includes: based on receiving an execution instruction associated with a preset computing task from a host, acquiring, from a storage of the host, data associated with execution of the preset computing task, wherein the preset computing task is a computing task that, when performed by the host, includes data exchange between the storage and a CPU with a frequency higher than a preset degree and configured for computing power lower than a preset computing power; storing the data in a memory associated with the PNM device; obtain a computing result corresponding to the preset computing task based on performing the preset computing task using the data exchange performed with the memory associated with the PNM device; and transmitting the computing result to the host.

According to an aspect of the present disclosure, there is provided a computing task management apparatus for a database, wherein the apparatus is applied to a process near memory device and includes: data acquisition processor configured to: based on receiving an execution instruction associated with a preset computing task from a host, acquire, from a storage of the host, data associated with execution of the preset computing task, wherein the preset computing task is a computing task that, when performed by the host, includes data exchange between the storage and a CPU with a frequency higher than a preset degree and configured for computing power lower than a preset computing power; store the data in a memory associated with the PNM device; a task executor configured to obtain a computing result corresponding to the preset computing task based on performing the preset computing task using the data exchange performed with the memory associated with the PNM device; and a computing result transmitter configured to transmit the computing result to the host.

According to an aspect of the present disclosure, there is provided a computing task management system for a database, where the system includes a host and a process near memory device, and where the host is configured to: transmit an execution instruction associated with a preset computing task to the PNM device; and receive a computing result transmitted by the PNM device; and the PNM device is configured to: based on receiving the execution instruction associated with the preset computing task from the host, acquire, from a storage of the host, data associated with execution of the preset computing task, and store the data in a memory associated with the device, wherein the preset computing task is a computing task that, when performed by the host, includes data exchange between the storage and a CPU with a frequency higher than a preset degree and configured for computing power lower than a preset computing power; perform the preset computing task using the data exchange performed with the memory associated with the PNM device to obtain the computing result corresponding to the preset computing task; and transmit the computing result to the host.

According to another aspect of the present disclosure, there is further provided an electronic device. The electronic device includes: at least one processor; at least one memory storing computer-executable instructions, wherein the computer-executable instructions, when run by the at least one processor, cause the at least one processor to perform a computing task management method for a database as described above.

According to another aspect of the present disclosure, there is further provided a computer readable storage medium storing instructions, wherein the instructions, when run by at least one processor, cause the at least one processor to perform a computing task management method for a database as described above.

According to another aspect of the present disclosure, there is further provided a system including at least one computing apparatus and at least one storage apparatus storing instructions, wherein the instructions, when run by the at least one computing apparatus, cause the at least one computing apparatus to perform a computing task management method for a database as described above.

According to another aspect of the present disclosure, there is further provided a computer program product including a computer program/instruction, wherein the computer program/instruction, when run by a processor, implements a computing task management method for a database as described above.

### BRIEF DESCRIPTION OF DRAWINGS

The accompanying drawings herein, which are incorporated into and form a part of the specification, illustrate embodiments consistent with the present disclosure and are used in conjunction with the specification to explain the principles of the present disclosure and do not constitute an undue limitation of the present disclosure.

FIG. 1 illustrates a schematic diagram of an overall architecture and a data processing flow of RocksDB.

FIG. 2 illustrates a schematic diagram of a file compaction by RocksDB.

FIG. 3 illustrates a schematic diagram of a range query by RocksDB.

FIGS. 4A and 4B illustrate schematic diagrams of CXL-based memory expansion and CXL-PNM-based memory expansion.

FIG. 5 illustrates a flowchart of a computing task management method for a database applied to a PNM device in exemplary embodiments of the present disclosure.

FIG. 6 illustrates a schematic diagram of a function deployment of a system for performing a file compaction in exemplary embodiments of the present disclosure.

FIG. 7 illustrates a schematic diagram of a function deployment of a system for performing a range query in exemplary embodiments of the present disclosure.

FIG. 8 illustrates a schematic diagram of a process for performing a file compaction in exemplary embodiments of the present disclosure.

FIG. 9 illustrates a flowchart for performing a file compaction in exemplary embodiments of the present disclosure.

FIG. 10 illustrates a schematic diagram of a process for performing a range query in exemplary embodiments of the present disclosure.

FIG. 11 illustrates a flowchart for performing a range query in exemplary embodiments of the present disclosure.

FIG. 12 illustrates a schematic diagram of a system architecture for extending a PNM in exemplary embodiments of the present disclosure.

FIG. 13A and FIG. 13B illustrate a difference schematic diagram of comparing a file compaction and range query process of exemplary embodiments of the present disclosure with that of the related art.

FIG. 14 illustrates a schematic diagram of a difference between using PNM assistance and not using PNM assistance according to exemplary embodiments of the present disclosure.

FIG. 15 illustrates a block diagram of a computing task management apparatus for a database applied to a PNM device in exemplary embodiments of the present disclosure.

FIG. 16 illustrates a block diagram of a computing task management system for a database in exemplary embodiments of the present disclosure.

FIG. 17 is a block diagram of an electronic device according to an exemplary embodiment of the present application.

### DETAILED DESCRIPTION

In order to enable a person of ordinary skill in the art to better understand technical solutions of the present disclosure, the technical solutions in the embodiments of the present disclosure will be described clearly and completely in the following, in conjunction with the accompanying drawings.

It is noted that terms “first”, “second” and the like in the specification and claims of the present disclosure and the above accompanying drawings are used for distinguishing similar objects, and need not to be used for describing a particular order or sequence. It should be understood that data so used may be interchanged, where appropriate, so that the embodiments of the present disclosure described herein may be implemented in an order other than those illustrated or described herein. The embodiments described in the following embodiments do not represent all embodiments consistent with the present disclosure. Rather, they are only examples of apparatuses and methods consistent with some aspects of the present disclosure as detailed in the appended claims. In the present disclosure, a singular form such as “a”, “an” or “the” may also refer to a plural form.

It is noted herein that a phrase “at least one of several items” as it appears in the present disclosure is intended to encompass three parallel cases of “any one of the several items”, “a combination of any number of the several items”, and “all of the several items”. For example, “including at least one of A and B” includes the following three parallel cases:
(1) including A; (2) including B; and (3) including A and B. Another example is “performing at least one of step 1 and step 2”, which represents the following three parallel cases: (1) performing step one; (2) performing step two; and (3) performing step one and step two.

Exemplary embodiments in the present disclosure relate to RocksDB, but a person of skill in the art will understand that aspects of the present disclosure can be applied to databases with similar problems.

The technical solutions provided by the present disclosure have at least the following beneficial effects:
According to the computing task management method for a database, the apparatus, the electronic device, the storage medium, the system, and the computer program product of the present disclosure, the process near memory (PNM) characteristics of the PNM device may be utilized to rebuild the computing architecture of the storage model such as RocksDB, in order to offload, from the CPU to the PNM device, the computing task involved in the data operation. Such computing tasks may include range query and file compaction tasks for database space optimization that requires frequent data replication and movement between the CPU and the memory just for the CPU to perform simple computations in the database. This significantly reduces the amount of data read into the memory, reduces the burden on the memory, releases the resource utilization of the CPU, and reduces the data interaction between the CPU and the memory. It further reduces the impact of a large number of data computations on the performance of the storage engine and increases the memory bandwidth. This in turn improves the execution performance and efficiency of the storage engine system.

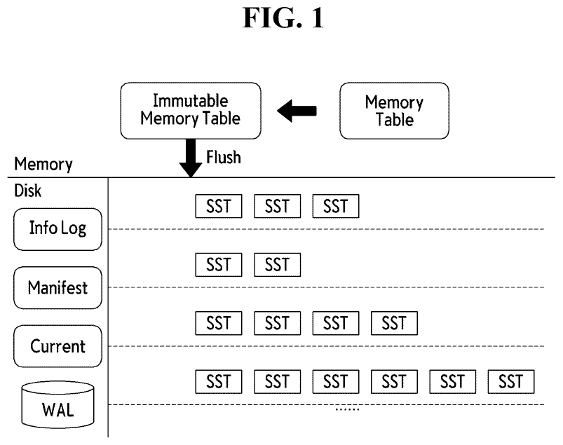

RocksDB may store any binary Key-Value (KV) data, and at the same time it may organize all the data sequentially. The underlying implementation in RocksDB uses a LSM tree structure to improve write performance, so its application scenarios are write-intensive. An overall architecture and a data processing flow of RocksDB is described below in FIG. 1.

FIG. 1 illustrates a schematic diagram of an overall architecture and a data processing flow of RocksDB in the related art.

Referring to FIG. 1, RocksDB is a key-value storage system, in which a LSM tree structure is a storage engine for fast storage and access of key-value data. LSM tree structure adopts a multi-tiered structure, including a memory table (MemTable) in a memory and a Sorted String Table (SST) (e.g., ordered storage file) on a disk, etc. The design of the LSM tree allows RocksDB to efficiently handle a large number of write operations and to provide excellent read performance.

In RocksDB, an information log (info log), a manifest file (manifest), a current file or a current pointer (Current), a Write-Ahead Logging (WAL) and the SST on disk are key components, which work together to maintain the consistency and performance of the database.

The data processing flow of RocksDB may include the following steps: (1) data may be first written to a memory table in the memory, the memory table is an ordered data structure; (2) when the data in the memory table reaches a certain size, it will be converted to an immutable memory table (i.e., read-only), at the same time, a new memory table will be generated for writing data later; (3) RocksDB may flush the data in the immutable memory table into the SST according to a policy, and then it may compact the SSTs on a level-by-level basis. A file compaction operation of each level in the SST has a threshold value, if the threshold trigger is reached, the file compaction operation will be performed.

In the LSM tree structure, the SST is an important component that may be used to store sorted key-value pairs for quick searching based on keys. Each SST saves a portion of the data and these data is sorted by keys. This design allows RocksDB to perform a range query and sequential read efficiently. When the memory table is filled, it is flushed to the SST and stored, thus enabling persistent storage of data.

Overall, the LSM tree structure and the SST may work together in RocksDB to achieve high-performance key-value storage and access functionality.

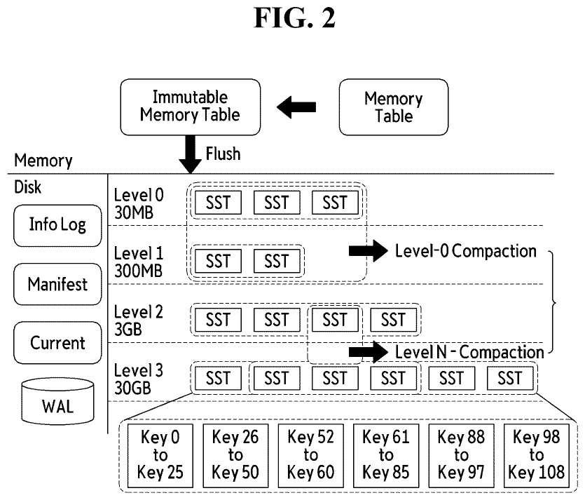

In order to make tradeoffs between read amplification, space amplification, and write amplification, RocksDB performs flush and file compaction. When core key-value data is managed using the LSM tree, compaction is used to compact and organize data to optimize read performance and reduce storage space occupation. RocksDB uses compaction to avoid the impact on read performance caused by an overly redundant LSM tree. There are many compaction methods, and one of the more commonly used methods is described in FIG. 2.

FIG. 2 illustrates a schematic diagram of a file compaction by RocksDB.

Referring to FIG. 2, RocksDB may include data of multiple levels, e.g., level 0˜level 3, etc. The size of data in each level may be different, and a next level may be several times larger than a previous one. Level 0 may not be globally ordered, but only a file in level 0 is ordered. Other levels may be globally ordered. Each SST saves a part of the data, and this data is sorted by keys, for example, in each SST of level 3, key-value pairs with Key0˜Key25, Key26˜Key50, Key52˜Key60, Key61˜Key85, Key88˜Key97, Key98˜Key108, etc. are saved in order. The file compaction is a process of selecting SSTs with overlapping keys using some simple rules and generating new SSTs by compacting and sorting. This process duplicates a lot of data between a memory (e.g., Dynamic Random Access Memory (DRAM)) and a CPU just to allow the CPU to perform simple repetitive operations. As may be seen, the file compaction may occupy a lot of CPU resources. Specifically, when RocksDB reaches a trigger condition of the file compaction and if the CPU is idle, file compaction in RocksDB will always run.

As for the range query, compared with the write performance of RocksDB, the performance of the range query is poor, and it often needs to query the memory and SSTs of each level.

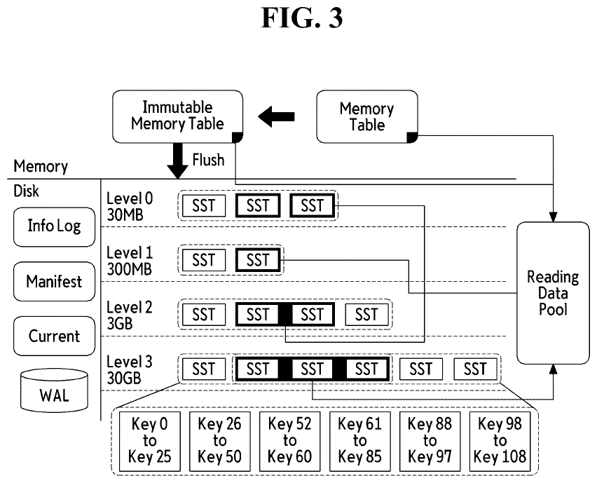

FIG. 3 illustrates a schematic diagram of a range query by RocksDB.

Referring to FIG. 3, blocks with thicker borders indicate that a range query condition overlaps with data in the region, which needs to be read, i.e., read a data pool. The range query mainly involves two processes: (1) finding files overlapping with the range query condition in SSTs of each level in a memory and a disk; and (2) summarizing the results and returning them to an upper-level application. The process of the range query also involves a large amount of data replication between the memory and the CPU, but only aims to allow the CPU to perform a large number of simple repetitive computations, such as binary search and file matching for a filters, e.g., a Bloom filter.

Optimization solutions for the file compaction may include optimizing parameters for the file compaction, or dividing a file compaction thread into multiple sub-threads to run the file compaction in parallel, etc. However, improper optimization of these solutions may lead to write stalling, which greatly reduces the performance of RocksDB, and also may still occupy a large amount of CPU resources.

Optimization solutions for the range query may be to adopt a prefix Bloom filter instead of the Bloom filter for file matching. However, this usually leads to the disadvantages of increasing the number of misjudgments, and the CPU still compares the files with the Bloom Filter several times.

As is known, related technical solutions all suffer from the following key problems: (1) they consume a large amount of CPU resources, and some performance optimization solutions have side effects in some cases; (2) they cannot fundamentally free up CPU resources to improve the performance; and (3) the CPU spends a large amount of time performing simple and frequent tasks.

In short, none of the related technical solutions solves the problem that there is a large number of data movement and data replication between the CPU and the memory involved in the file compaction and the range query in RocksDB, just to allow the CPU to perform simple computations.

In order to solve the above problems, the present disclosure provides a computing task management method for a database, and an apparatus, an electric device, a storage medium, a system and a computer program product thereof, which utilizes PNM characteristics of the PNM device to rebuild a computing architecture of a storage model such as RocksDB. Using this architecture, computing tasks in data operations are offloaded from the CPU to the PNM device. Some exemplary computing tasks may include data operations such as the file compaction, the range query in a storage engine such as RocksDB, etc., which require frequent data replication and movement between the CPU and the memory but only for the CPU to perform simple computations. The present disclosure significantly reduces the amount of data read into the memory, reduces the burden on the memory, releases the resource utilization of the CPU, and reduces the data interaction between the CPU and the memory. Thereby reducing the impact of a large number of data computations on the performance of the storage engine, and increasing the memory bandwidth. This in turn improves the execution performance and efficiency of the storage engine system.

It may be appreciated that the computing task management method for a database, and the apparatus, the electric device, the storage medium, the system and the computer program product thereof provided by the present disclosure may also be applied to other key-value storage databases other than RocksDB, or databases such as columnar storage databases, document databases, graph databases, and databases that use a structure similar to a LSM tree structure, such as LevelDB, Cassandra, HBase, BadgerDB, etc., and the commonalities of these databases may include the need to handle data operations that perform frequent data replication and movement between the CPU and the memory only for the CPU to perform simple computations, such as the file compaction, the range query, and other data operations. RocksDB is used as an example to explain the present disclosure.

PNM is a technology that integrates a memory and a logic chip into an advanced integrated circuit package. It may reduce data movement between a CPU and the memory by utilizing the logic chip for data computation.

In a case of PNM, computing functions may be performed closer to the memory to reduce the bottleneck of data transmission between the CPU and the memory.

Compute Express Link™ (CXL™) is an open standard for high-speed processor-to-device and processor-to-memory interface that allows for more efficient utilization of the memory and an accelerator used with the processor. The CXL technology allows for interconnection of disparate compute and storage resources to improve system performance and efficiency. CXL™ may be used in conjunction with other technologies, such as PNM, to help facilitate memory capacity expansion.

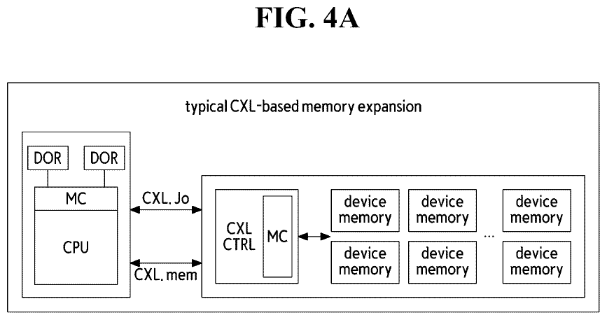

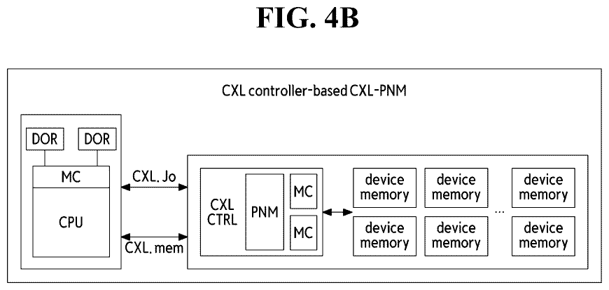

FIG. 4 illustrates a schematic diagram of CXL-based memory expansion and CXL-PNM-based memory expansion.

Referring to FIG. 4A, a CXL-based memory expansion in the related technology is illustrated. A CPU and a device memory of the CXL may be connected via a CXL controller (CXL CTRL) to realize high-speed, low-latency, and high-bandwidth data transmission and sharing between computing resources such as the CPU and storage resources such as the device memory of the CXL.

Referring to FIG. 4B, a combination of the CXL and a PNM technology via the CXL controller to realize CXL-PNM memory expansion based on the CXL controller in the related art is illustrated. The CXL technology may provide a high-speed, low-latency data transmission channel that enables the CPU and an accelerator in the PNM to efficiently share and access memory resources.

There are several key components and concepts in the CXL technology as follows:
CXL CTRL: this is a control part of the CXL that may be used to manage and control CXL connection and communication. It may handle protocols and signals related to the CXL and ensure that the communication between devices is correct.
Device On-Ramp (DOR): The DOR is a device access point that may allow devices (such as accelerator, memory buffer, etc.) to connect to the CXL network. It may provide a standardized interface for devices to communicate with other components in the CXL network.
Memory Controller (MC): this is a component used to manage memory access. In a CXL environment, the MC ensures that access to a shared memory is efficient and consistent. In the CXL technology, the MC may work with the CPU of the host, with accelerator devices (e.g., PNM, etc.), or moved to a memory buffer chip.
CXL.Jo: this is a joint interface for the CXL that may allow two or more CXL devices to work together and share the memory and other resources. With CXL.Jo, the devices may be operated as a whole, thus improving overall performance and efficiency.
CXL.mem: this is a memory protocol for the CXL that may define a transmission interface between the CPU and the memory to ensure that the CPU may efficiently access and utilize the shared memory on the CXL network.
Device Memory: this may refer to a memory on an accelerator or other devices (e.g., host, etc.). In the CXL architecture, this memory may be shared and accessed by the CPU and other devices (e.g., PNM, etc.) to improve overall performance and resource utilization.

The PNM solutions based on the CXL interface may improve performance in applications that require high memory bandwidth.

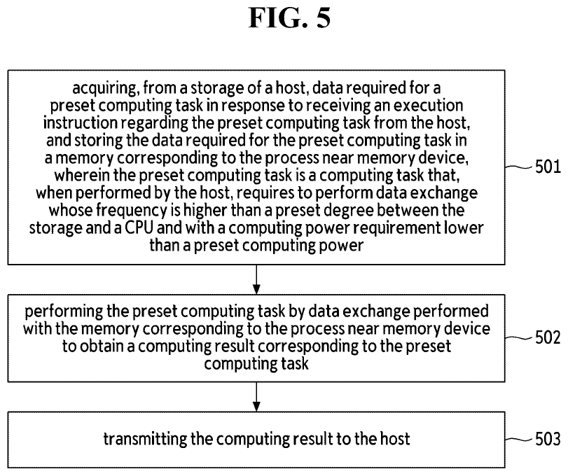

Below, a computing task management method for a database, and an apparatus, an electric device, a storage medium, a system and a computer program product of the present disclosure will be specifically described with reference to FIGS. 5 through 17.

According to exemplary embodiments of the present disclosure, an architecture system of the present disclosure may be a new function module added directly based on the CXL and the original design architecture of RocksDB, to realize a hot-plugging function of a computing unit and memory expansion, such that it is possible to add/remove the CXL device online at the CXL server as needed without destroying the original system. Specifically, PNM characteristics of the CXL-PNM storage device may be utilized to offload the computing task of the file compaction and the range query in RocksDB from the CPU to the CXL-PNM device, to obtain an accelerated computing architecture of the present disclosure. The CXL-based PNM scheme may substantially reduce the data interaction between the memory and the CPU in RocksDB and further improve the overall performance of RocksDB.

FIG. 5 illustrates a flowchart of a method of computing task management for a database as applied to a PNM device in exemplary embodiments of the present disclosure.

Referring to FIG. 5, at operation 501, in response to receiving an execution instruction regarding a preset computing task from a host, data required for the preset computing task may be acquired from a storage of the host, and the data required for the preset computing task may be stored in a memory corresponding to the PNM device, wherein the preset computing task may be a computing task that, when performed by the host, requires to perform data exchange whose frequency is higher than a preset degree between the storage and a CPU and with a computing power requirement lower than a preset computing power.

According to exemplary embodiments of the present disclosure, the storage of the host may be a persistent storage, such as a disk, a hard disk, etc. of the host.

According to exemplary embodiments of the present disclosure, the memory corresponding to the PNM device may be a memory of a CXL-PNM extended via a CXL interface, a memory of the host, and the like.

According to exemplary embodiments of the present disclosure, the preset computing task may be a computing task, that when performed by a CPU involves, a high frequency of data exchange between a memory and a CPU of a host and also includes a computing requirement that satisfies preset conditions. That is, the present computing task may include a computing task that requires frequent data replication and movement between the CPU and the memory only for the CPU to perform simple computations on the data, e.g., a computing task involved in a range query, a file compaction for database space optimization, etc.

According to exemplary embodiments of the present disclosure, the host may transmit, to the PNM device, an execution instruction for a computing task involved in a data operation such as the file compaction, the range query, and the like. The PNM device may receive, from the host, execution instructions for computing tasks involved in the file compaction, the range query, and other data operations. It will be appreciated that the execution instruction may include execution parameters for a corresponding computing task. The execution parameters for the file compaction may include, but are not limited to, a position and a size of a data block or file to be performed for compacting, a policy and a level of the file compaction, and the like. The execution parameters of the range query may include, but are not limited to, a range of keys to be queried, an iterator configuration (e.g., a traversal direction, whether to include boundary keys, etc.), and the like.

According to exemplary embodiments of the present disclosure, after the PNM device receives the execution instruction for the computing task involved in the data operation, the data required for the computing task may be read from a persistent storage, such as a disk, by the PNM device into a memory corresponding to the PNM device, so as to facilitate data exchange between the PNM device and the memory corresponding to the PNM device in the process of performing the computing task.

At step 502, the preset computing task may be performed by data exchange performed with the memory corresponding to the PNM device to obtain a computing result corresponding to the preset computing task.

According to exemplary embodiments of the present disclosure, the computing task involved in the data operation may be performed by the PNM device through the data exchange performed with the memory corresponding to the PNM device to obtain the corresponding computing result instead of by the CPU of the host. According to exemplary embodiments of the present disclosure, the host may include a controller corresponding to the preset computing task and a task dispatch module corresponding to the preset computing task. The controller may be configured to coordinate an execution process of the data operation corresponding to the preset computing task and generating a result of the data operation. The task dispatch module may be configured to perform at least one of interfacing with the PNM device, accessing the memory corresponding to the PNM device, transmitting execution parameters of the preset computing task, and the like.

According to an embodiment of the present disclosure, a controller for the file compaction and/or a controller for the range query may be deployed at the host side of RocksDB to be used for the overall process of the file compaction and the range query. A task dispatch module for the file compaction and/or a task dispatch module for the range query may also be deployed at the host side of RocksDB to dispatch computing tasks involved in corresponding data operations. The task dispatch module for the file compaction and/or a task dispatch module for the range query may also be deployed to interface with the PNM device, access the memory corresponding to the PNM device, transmit execution parameters of the corresponding computing tasks, etc.

According to an embodiment of the present disclosure, the PNM device may include a computing unit corresponding to the data operation configured to perform the computing task involved in the data operation.

According to embodiments of the present disclosure, the computing unit corresponding to the data operation, such as a computing unit for the file compaction and/or a computing unit for the range query, may be deployed in the PNM device, e.g., at the CXL-PNM device, such that the PNM device may process respective computing tasks involved in the data operations by the respective computing units.

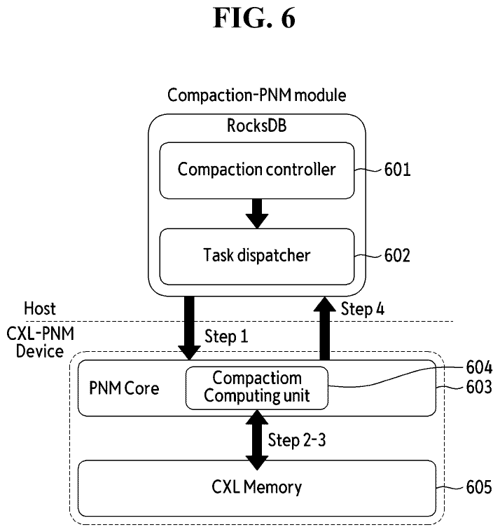

FIG. 6 illustrates a schematic diagram of a function deployment of a system for performing a file compaction in exemplary embodiments of the present disclosure.

Referring to FIG. 6, according to embodiments of the present disclosure, at the host side of RocksDB, may include a controller 601 and task dispatcher 602 (also referred to as task dispatcher module 602). The process of the file compaction may be coordinated by a controller 601 for the file compaction. The task dispatch module 602 for the file compaction may be configured to perform an interface interaction for accessing the memory of the CXL-PNM device, transmitting parameters of the computing task involved in the file compaction, receiving a computing result, and the like. The CXL-PNM device side may include computing unit 604 and computing core 603. The computing unit 604 may be used for the file compaction may be deployed in the computing core 603 of the PNM device for performing a computing process of a computing task involved in file compaction. During performing the computing process of the file compaction, data exchange may be carried out between the computing unit 604 for the file compaction and a CXL memory 605, e.g., the computing unit 604 for the file compaction may read data required for the computing task of the file compaction, etc., from the CXL memory 605. Upon completion of the computation, the computing unit 604 for the file compaction may return the computing result to the task dispatch module 602 for the file compaction at the host side.

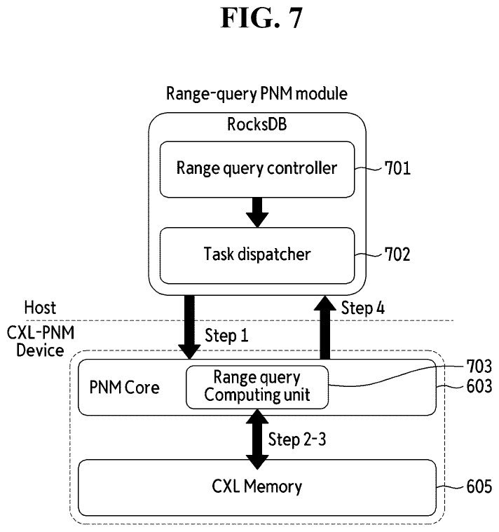

FIG. 7 illustrates a schematic diagram of a function deployment of a system for performing a range query in exemplary embodiments of the present disclosure.

Referring to FIG. 7, according to exemplary embodiments of the present disclosure, at the host side of RocksDB, a controller 701 for the range query may coordinate an entire process of the range query. The host side of RocksDB may also include a task dispatch module 702 for the range query may be configured to perform an interface interaction for accessing the memory of the CXL-PNM device, transmitting parameters of the computing task involved in the range query, receiving a computing result, and the like. At the CXL-PNM device side, a computing unit 703 for the range query may be deployed in the computing core 603 of the PNM device for performing the computing process involved in the range query. During the computing process of performing the range query, data exchange may be performed between the computing unit 703 for the range query and the CXL memory 605, e.g., the computing unit 703 for the range query may read data required for the computing task of the range query, etc., from the CXL memory 605. Upon completion of the computation, the computing unit 703 for the range query may return the computing result to the task dispatch module 702 for the range query at the host side.

According to embodiments of the present disclosure, when the preset computing task is the computing task involved in the file compaction, the acquiring of the data required for the preset computing task may include, but is not limited to, receiving, from the host, the execution instruction regarding the preset computing task. This execution instruction is received when the host detects that a trigger condition for the file compaction has been reached. The the trigger condition may include, but is not limited to, a threshold condition; and acquiring the data required for the preset computing task from the memory of the host in response to the execution instruction of the preset computing task.

According to embodiments of the present disclosure, the host side may detect whether the trigger condition for the file compaction is reached. In RocksDB, the trigger condition for the file compaction may include, but is not limited to a size threshold, time threshold, manual trigger, and background thread. The size threshold includes triggering the file compaction when a size of a certain MemTable or SST exceeds a preset threshold, which helps to ensure that the size of the database does not increase unboundedly. The time threshold includes triggering the file compaction even if the size threshold is not reached, if a time when a certain MemTable or SST exists exceeds a preset time, which helps to avoid long data retention and ensure data persistence. The manual trigger includes triggering the file compaction by a user or application manually. The background thread may include the background thread of RocksDB periodically checking and triggering a required file compaction in order to maintain the performance and efficiency of the database. When the host detects that the trigger condition for the file compaction has been reached, the host may transmit, to the PNM device, the execution instruction regarding the computing task involved in the file compaction, etc. The PNM device may respond after receiving from the host the execution instruction regarding the computing task involved in the file compaction, etc.

According to embodiments of the present disclosure, when the preset computing task is involved in the range query, the acquiring of the data required for the preset computing task may include, but is not limited to, receiving, from the host, the execution instruction regarding the preset computing task when a condition of the range query has been acknowledged by the host. The condition of the range query may include, but is not limited to, a start value and an end value of a query key; and acquiring the data required for the preset computing task from the memory of the host in response to the execution instruction of the preset computing task.

According to exemplary embodiments of the present disclosure, the condition of the range query may be confirmed by the host side when the range query is required. When performing the range query in RocksDB, a start key and an end key of the query, i.e., a start value and an end value of the query key, need to be specified to determine a range of the query. In embodiments, this range may be a closed interval, an open interval, or a half-open, half-closed interval, depending on the needs of the query. After the host side confirms the condition of the range query, the host side may transmit an execution instruction and the like of the computing task involved in the range query to the PNM device, so that the PNM device may respond after receiving the execution instruction and the like transmitted by the host side.

Referring back to FIG. 5, at operation 503, the computing result may be transmitted to the host.

According to embodiments of the present disclosure, after the PNM device performs a computing task and obtains a computing result, the computing result may be transmitted from the PNM device to the host side. This way, a result of the corresponding data operation may be obtained at the host side based on the received computing result. This process significantly frees up CPU resources, reduces frequent data replication and exchange between the CPU and the memory, and generally improves the efficiency of the CPU.

According to exemplary embodiments of the present disclosure, when the preset computing task is associated with the file compaction, the performing the preset computing task may include, but is not limited to: determining a file to be compacted for the file compaction; reading respective key-value pairs in the file to be compacted from the memory corresponding to the PNM device; sorting the respective key-value pairs in a key order by, e.g., comparing keys of the respective key-value pairs and exchanging the respective key-value pairs; and obtaining a sorted sequence of key-value pairs in the memory corresponding to the PNM device.

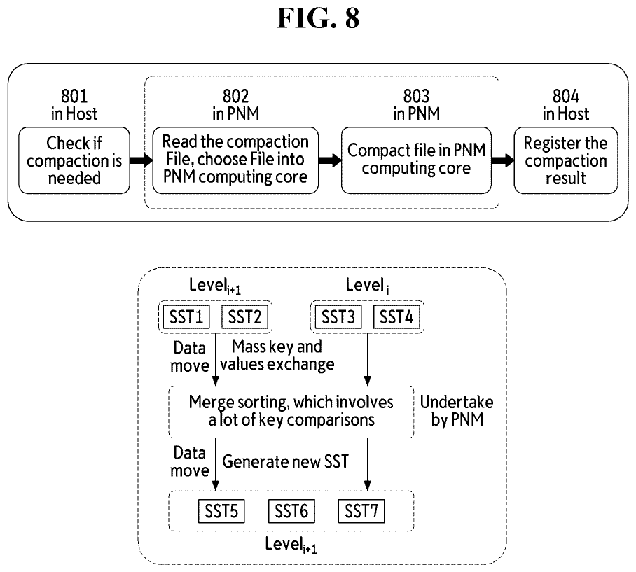

FIG. 8 illustrates a schematic diagram of a process for performing a file compaction in exemplary embodiments of the present disclosure.

Referring to (a) of FIG. 8, according to exemplary embodiments of the present disclosure, the process of the file compaction may include the operations shown in FIG. 8. At operation 801, the host may check whether the file compaction is currently required. Once it is required, at operation 802, a file to be compacted may be selected to be read into the computing core (including the computing unit) of the PNM device. Then, at operation 803, the file compaction may be performed for the file to be compacted in the computing core of the PNM device. Then, at operation 804, a result of the file compaction may be recorded at the host side. The operations 801 and 804 processed at the host side may be achieved by using the controller 601 and the task dispatch module 602 mentioned above. The operations 802 and 803 may be processed at the CXL-PNM side, and may include receiving parameters and processing the computing task involved in the data operation, and returning the computing result.

Referring to (b) of FIG. 8, it illustrates operations 802 and 803 in detail according to exemplary embodiments of the present disclosure. In embodiments, the process of performing the computing task involved in the file compaction by the PNM device may include determining files of which level or levels to be compacted (SSTs) need to be compacted, and these files to be compacted may be read from the disk and the like into the memory. Then, a compacting and sorting operation involving comparison of a lot of keys may be performed by the PNM device: each key-value pair in the file to be compacted is read from the memory (data movement from the memory to the PNM device), and the keys of respective key-value pairs are compared, and the key-value pairs are exchanged in order to sort the key-value pairs in key order. In embodiments, the sorted sequence of key-value pairs may be obtained in the memory (the computing result corresponding to the file compaction), and the sequence of key-value pairs may be transferred to a host through the data movement from the PNM device to the memory in order to generate a compacted file based on the sorted sequence of key-value pairs on the host side (the result of the file compaction).

According to exemplary embodiments of the present disclosure, in the process of performing the computing task of the file compaction by the PNM device, a large amount of data replication is performed between the computing core of the PNM device and the CXL memory instead of the memory and CPU. This reduces the transmission distance as compared to performing a large amount of data replication between the CPU and the memory. Additionally, a large amount of simple computations are performed by the computing core of the PNM device, which significantly frees up CPU resources as compared to performing the computations by the CPU.

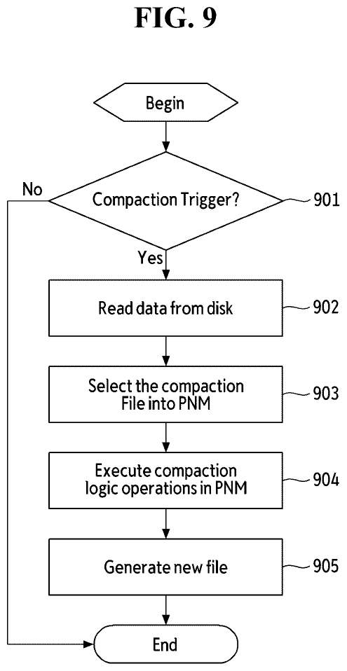

FIG. 9 illustrates a flowchart for performing a file compaction in exemplary embodiments of the present disclosure.

Referring to FIG. 9, according to exemplary embodiments of the present disclosure, in the process of performing the file compaction, at operation 901, a state of a file compaction trigger may be determined, e.g., by judging a trigger condition such as any one or more of the thresholds described above. If a trigger condition of a corresponding threshold is not reached, the process ends. if the trigger condition of the corresponding threshold is reached, at operation 902, data required for the file compaction may be read from a disk or a persistent storage such as a Solid State Drive (SSD) into the CXL memory. Then, at operation 903, a file to be compacted may be selected from the memory to the PNM device. At operation 904, a logical operation for the file compaction, such as key comparison, key sorting, compacting sequences of key-value pairs (compacting and sorting), may be performed in the PNM device. At operation 905, the sorted sequence of key-value pairs may be further compacted based on the result of the logical operation to generate a new file as a result. This process may use the computing core of the CXI-PNM to perform the operations 902 to 904 of the compression operation instead of the CPU, so that the compression operation is not performed when the CPU is busy. Additional advantages include: saving the data transmission time, reducing the data transmission distance, not consuming a large amount of CPU utilization resources, and ensuring that the compaction is always in progress.

According to exemplary embodiments of the present disclosure, when the preset computing task is involved in the range query, the performing the preset computing task may include, but is not limited to: reading a memory table from the memory corresponding to the PNM device; traversing key-value pairs in the memory table and, in a case where a condition of the range query is not fully covered by the memory table, reading, through a Bloom filter, an ordered string table that satisfies the condition of the range query from the storage to the memory corresponding to the PNM device; and collecting, from the memory table and the ordered string table, all key-value pairs that satisfies the condition of the range query.

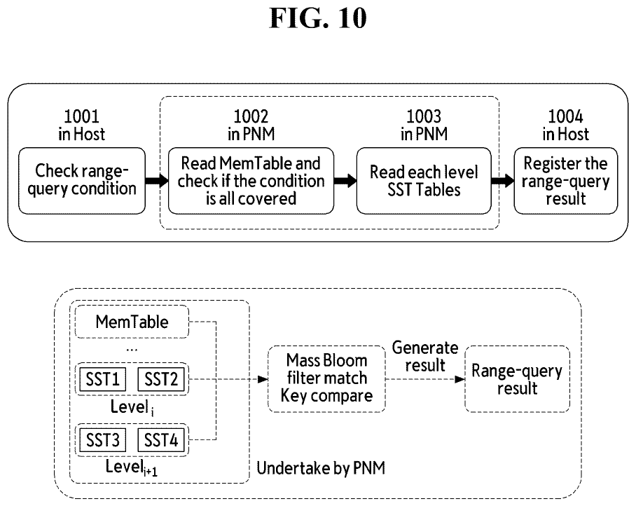

FIG. 10 illustrates a schematic diagram of a process for performing a range query in exemplary embodiments of the present disclosure.

Referring to (a) of FIG. 10, according to exemplary embodiments of the present disclosure, the process of the range query may include operations shown in FIG. 10. At operation 1001, a condition of a current range query may be confirmed in the host. Then, at operation 1002, the PNM device may read a MemTable from the memory and may confirm whether the condition of the range query is fully covered or not. When the range query is not being fully covered, at operation 1003, the PNM device may read SSTs of each level that satisfy the condition of the range query into the memory from the disk, etc., at which step a Bloom filter may be used to perform a key comparison and a key match to read SSTs of each level that satisfy the condition of the range query. then, at 1004, the results of the range query may be recorded at the host side. The operations 1001 and 1004 may be processed at the host side, which may mainly use the controller 701 and the task dispatch module 702 for the range query mentioned above, and the operations 1002 and 1003 may be processed by the CXL-PNM side, which may include receiving parameters, processing the corresponding computing task and returning the computing result.

Referring to (b) of FIG. 10, it illustrates operations 1002 and 1003 in detail according to exemplary embodiments of the present disclosure. In the process of performing the computing task of the range query, the PNM device may perform the following steps. A MemTable may be first read from the memory and key-value pairs in the MemTable may be traversed to determine whether or not the condition of the range query is fully covered by the MemTable. When the condition of the range query is not fully covered by the memory table, a SST that satisfies the condition of the range query may be read into the memory from a persistent storage such as the disk through a Bloom filter; finally, all the key-value pairs that satisfy the condition of the range query (the computing result corresponding to the range query) may be collected in the MemTable and all the SSTs that have been read and may be returned to the host in order to get the result of the range query through the host. Since RocksDB uses a hierarchical (multi-level) storage structure, each level contains multiple SST files, the query may start reading from a SST file of a lowest level and go up level by level. When the query range spans multiple SSTs and/or SSTs of multiple levels, data in these files may be read and compacted. The Bloom filter, or any suitable filter, may help quickly determine whether a key exists in a particular SST through key comparison. This avoids unnecessary disk I/O operations on unnecessary files; thus, a SST containing a target key may be located more efficiently and the range query may be performed.

According to exemplary embodiments of the present disclosure, during the range query processing by the PNM device, a large number of Bloom filters may be involved for key comparison and key matching, a large amount of data copy may be performed between the computing core of the PNM device and the CXL memory to complete the Bloom filtering. This may save data transmission loss and transmission distance compared to the large amount of data copy performed between the CPU and the memory. Additionally, because the PNM device performs a large number of simple computations it significantly releases CPU resources compared to performing the computations by the CPU. Moreover, in the range query, the query may start from a component of a lowest level to compact and process data level by level; the data may be effectively filtered and screened at an earlier level or stage, so that only data that satisfies the query condition may be passed to an upper level for further processing. This avoids unnecessary transmission to the upper level; therefore, the earlier the data is processed, the less data will be returned upward, and the amount of data passed upward in each level is reduced, and the query result returned ultimately will be more accurate and efficient.

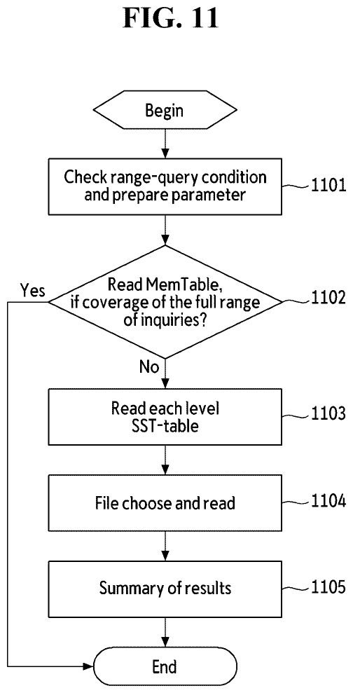

FIG. 11 illustrates a flowchart for performing a range query in exemplary embodiments of the present disclosure.

Referring to FIG. 11, according to exemplary embodiments of the present disclosure, in the process of performing the range query, at operation 1101, a condition of the range query may be checked as well as relevant parameters may be prepared and calibrated. For example, a start key and an end key of the range query may be checked to determine whether they are legal, such as whether they are empty, whether they are in a correct format, etc. As another example, parameters passed to a range query function or method may be verified to determine whether they are in accordance with expectations, such as a type, a number, and a value range of the parameters, etc., and a validity check may also be carried out for certain optional parameters, such as a parameter that restricts a number of results to be returned. At operation 1102, a MemTable may be read from the memory and whether the condition of the range query is fully covered by the MemTable may be checked, and if the condition of the range query is fully covered, the process is terminated. If the condition of the range query is not fully covered by the MemTable, at operation 1103, SST data of each level may be read in turn to cover the condition of the range query. At operation 1104, a file that satisfies the condition of the range query may be selected and read, this step is a core step of the range query, which may be performed in the PNM device, and may mainly include Bloom filter-based file matching (key comparison for key matching). At operation 1105, the result may be summarized and the result read by the range query may be returned to the upper level application. During performing the range query, the CXL-PNM computing core may be used instead of the CPU to perform the range query to avoid a large amount of data transmission between the CPU and the DRAM. Moreover, computing in advance ensures that the less useful data needs to be transmitted to the upper level, the redundancy of the data is less. Thus, some useless data does not need to be transmitted, and data transmission loss is reduced.

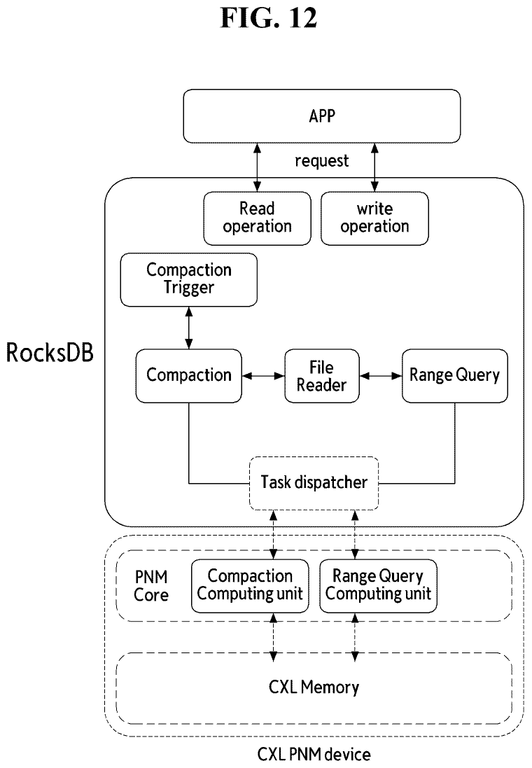

FIG. 12 illustrates a schematic diagram of a system architecture for extending a PNM in exemplary embodiments of the present disclosure.

Referring to FIG. 12, according to exemplary embodiments of the present disclosure, information about read operations and write operations may be exchanged between an upper level application and RocksDB by request. After the host side of RocksDB detects that a file compaction trigger has been triggered, and/or, receives a command regarding the range query from the upper level application, SST data of the file compaction and/or the range query may be read via a file reader. Further, computing tasks of the file compaction and/or the range query may be dispatched via a task dispatch module (task dispatcher) to a computing core (e.g., a computing unit) of a CXL-based PNM device (CXL PNM) and may be processed in the computing core. In embodiments, the computing core of the PNM may deploy a computing core for the file compaction and a computing core for the range query, to process the computing tasks of the file compaction and the range query. During performance of the computing tasks, data interaction may be performed with the CXL memory by the computing core for the file compaction and the computing core for the range query. The solid line boxes and arrows in FIG. 12 are parts that do not require PNM assistance, and the processes and/or operations in this part may be the same as in the related technology, where all the data may be read into the DRAM (memory), and the data exchange may be carried out between the CPU and the DRAM. The dotted line arrows in FIG. 12 are parts that require PNM assistance, and the process in these parts may read the data required for the computation into the CXL memory, and the data exchange may be carried out between the between the CXL-PNM and the CXL memory. As for RocksDB, the computing process of the file compaction and the execution process of the range query may be modified and controlled by the appropriate application program in the CXL-PNM device to accommodate this new architecture.

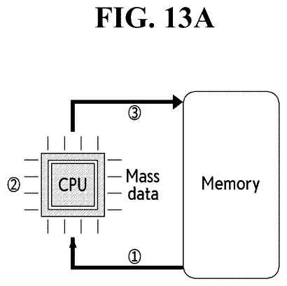

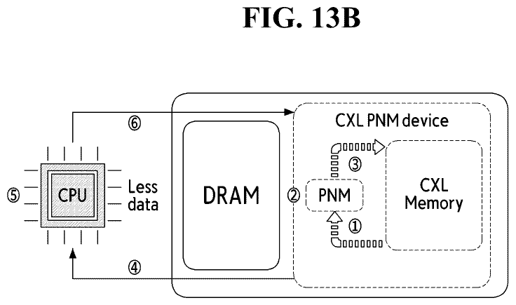

FIG. 13 illustrates a difference schematic diagram of comparing a file compaction and range query process of exemplary embodiments of the present disclosure with that of the related art.

Referring to FIG. 13A, in the related art, when performing the file compaction and the range query, at \textcircled{1}) a large amount of data is read from the DRAM to the CPU, then at \textcircled{2} a computing process of the read data is performed in the CPU, and finally at \textcircled{3} a large amount of computing results are returned to the DRAM. For the process of the file compaction and the range query, the overhead is mainly in parts \textcircled{1} and \textcircled{3} which cause a lot of data migration, as well as a serious consumption of CPU resources, and spending a lot of time on data transmission also causes additional CPU time overhead.

Referring to FIG. 13B, according to exemplary embodiments of the present disclosure, the CXL-based PNM device may be extended such that when performing the file compaction and the range query: at \textcircled{1} required data may be read from the CXL memory into the PNM device, and at \textcircled{2} a data computing process is performed in the PNM device. Then at \textcircled{3} a computing result may be returned to the CXL memory. Thus, at \textcircled{4} less data (e.g., computing result data rather than the data required for the computing process) may be read from the CXL memory to the CPU, at \textcircled{5} only a scheduling work and integration of the final result may be performed in the CPU rather than performing the computing process, and finally, at \textcircled{6} less data may be returned to the CXL.

As may be seen from FIG. 13A and B, it may be found that all the data interactions in the related art are performed between the DRAM and the CPU, which increases the resource overhead of both the CPU and the DRAM. For the computing architecture presented in this disclosure, a large amount of data copy and movement occurs within the CXL-PNM device, and internal data migration may save time and space overhead, and a large number of simple computations may be shifted to the PNM, which may offload the task burden from the CPU, resulting in a small workload for the CPU and improving the overall execution efficiency.

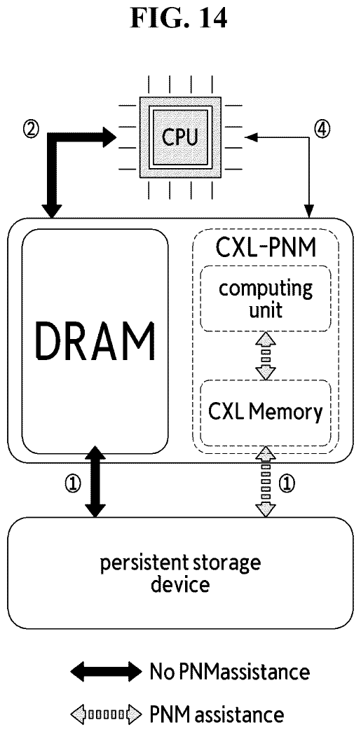

FIG. 14 illustrates a schematic diagram of a difference between using PNM assistance and not using PNM assistance according to exemplary embodiments of the present disclosure.

Referring to FIG. 14, in the related art, when the PNM assistance is not used, at \textcircled{1} labeled in solid line, data in the DRAM is transmitted to a persistent storage device, and/or, persistent data is read to the DRAM; at \textcircled{2} labeled in solid line, a large amount of data is read from the DRAM by the CPU, a computing process is performed by the CPU, and the data is written to the DRAM by the CPU. At \textcircled{2} labeled in solid line, a computing process is a simple computation, but data interaction between the CPU and the DRAM consumes a lot of time, and when the computing process performed by the CPU requires a large amount of data, this will cause a huge waste of CPU resources. It is observed that the time overhead spent on this process is not worthwhile because there is a serious mismatch between the time overhead and the computation overhead.

Still referring to FIG. 14, according to exemplary embodiments of the present disclosure, when the PNM is used for assistance, at \textcircled{1} labeled in dotted line, data in the CXL-PNM memory may be transmitted to a persistent storage device and/or, persistently stored data may be read from the persistent storage device to the CXL-PNM memory; and at \textcircled{2} labeled in dotted line, a large amount of data is moved only for simple computation, and thus the computing task may be performed by the PNM instead of the CPU, and the data may be moved only within the CXL-PNM device (between the computing unit of the PNM and the CXL memory). Then, at \textcircled{4}, the CPU may read only the result data of the computing task from the CXL memory, which is a substantial reduction of data compared to reading all the data involved in the computation. Moreover, the CPU may only perform dispatch of the computing task and the processing of the computing result. The CPU may perform only dispatch of the computing tasks and the processing of the computing results, and the CPU may write less of the final result data to the CXL memory instead of exchanging with the memory all the data required for the computing task.

As may be seen, performing the computing task by the PNM may offload data replication and movement, and simple computations from the CPU to the PNM device, and the PNM device may reduce the distance and time of data transmission and improve system execution efficiency and memory bandwidth by performing simple computations through a closer physical space between the memory and the computing core.

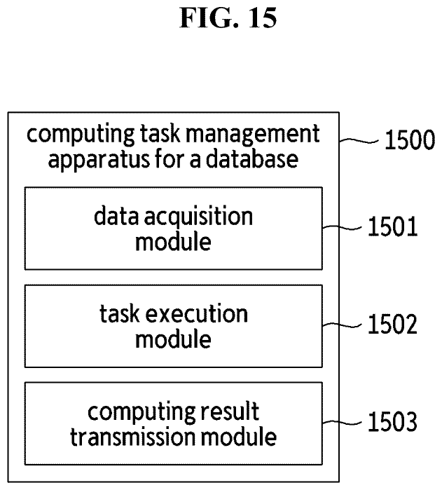

FIG. 15 illustrates a block diagram of a computing task management apparatus for a database applied to a PNM device in exemplary embodiments of the present disclosure.

Referring to FIG. 15, exemplary embodiments of the present disclosure further provides a computing task management apparatus 1500 for a database applied to a PNM device, which may include, but is not limited to, a data acquisition module 1501, a task execution module 1502, and a computing result transmission module 1503.

The data acquisition module 1501 (also referred to as data acquisition processor 1501) may acquire, from a storage of a host, data required for a preset computing task in response to receiving an execution instruction regarding the preset computing task from the host, and store the data required for the preset computing task in a memory corresponding to the PNM device, wherein the preset computing task may be a computing task that, when performed by the host, requires to perform data exchange whose frequency is higher than a preset degree between the storage and a CPU and with a computing power requirement lower than a preset computing power.

The task execution module 1502 (also referred to as task executor 1502) may perform the preset computing task by data exchange performed with the memory corresponding to the PNM device to obtain a computing result corresponding to the preset computing task.

The computing result transmission module 1503 (also referred to as computing result transmitter 1503) may transmit the computing result to the host.

It is to be understood that each module in the above computing task management apparatus 1500 for a database applied to the PNM device is used to realize the above computing task management method for a database applied to the PNM device, and the specific implementation process in the exemplary embodiment is substantially the same as that described in the above computing task management method for a database applied to the PNM device or applied to the host, and will not be repeated here. The computing task management apparatus 1500 for a database applied to the PNM device may be configured as software, hardware, firmware, or any combination thereof that performs specific functions, respectively. For example, these modules in the apparatus may correspond to pure software code, to specialized integrated circuits, or to modules combining software and hardware. In addition, one or more of the functions implemented by these modules in the apparatus may also be uniformly performed by components in a physical entity device (e.g., a processor, client, or server, etc.).

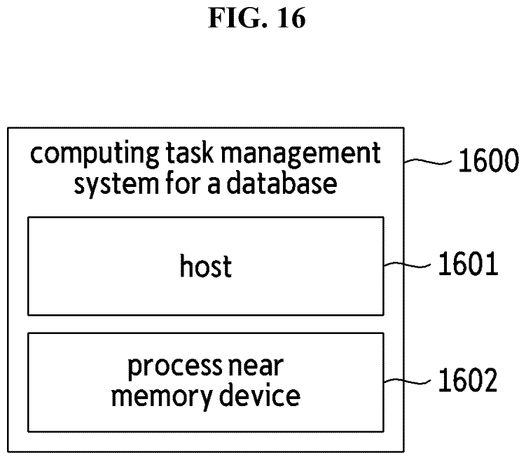

FIG. 16 illustrates a block diagram of a computing task management system for a database in exemplary embodiments of the present disclosure.

Referring to FIG. 16, exemplary embodiments of the present disclosure also provide a computing task management system 1600 for a database, where the computing task management system 1600 for a database may include a host 1601 and a PNM device 1602.

The host 1601 may be configured to transmit an execution instruction regarding a preset computing task to the PNM device 1602.

The PNM device 1602 may be configured to acquire, from a storage of the host 1601, data required for the preset computing task in response to receiving the execution instruction regarding the preset computing task from the host 1601, and store the data required for the preset computing task in a memory corresponding to the PNM device 1602, wherein the preset computing task may be a computing task that, when performed by the host 1601, requires to perform data exchange whose frequency is higher than a preset degree between the storage and a CPU and with a computing power requirement lower than a preset computing power.

The PNM device 1602 may be configured to perform the preset computing task by data exchange performed with the memory corresponding to the PNM device 1602 to obtain a computing result corresponding to the preset computing task.

The PNM device may be configured to transmit the computing result to the host 1601.

The host 1601 may be configured to receive the computing result transmitted by the PNM device.

It is to be understood that the above computing task management system 1600 for a database is used to implement the above computing task management method for a database applied to the PNM device and applied to the host, and that the specific implementation process in the exemplary embodiment is substantially the same as that described in the above computing task management method for a database applied to the PNM device or applied to the host, and will not be repeated here.

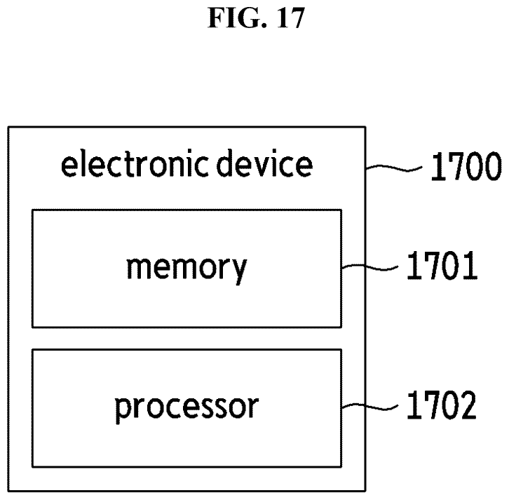

FIG. 17 is a block diagram of an electronic device according to an exemplary embodiment of the present application.

Referring to FIG. 17, an electronic device 1700 includes at least one memory 1701 and at least one processor 1702, the at least one memory 1701 stores a computer-executable instruction set, when the computer-executable instruction set is executed by the at least one processor 1702, a computing task management method for a database according to an exemplary embodiment of the present application is performed.

As an example, the electronic device 1700 may be a PC computer, a tablet apparatus, a personal digital assistant, a smart phone, or any other apparatus capable of executing the above instruction set. Here, the electronic device 1700 does not have to be a single electronic device, but may also be any set of apparatuses or circuits capable of executing the above instructions (or instruction set) individually or jointly. The electronic device 1700 may also be a part of an integrated control system or system manager, or may be configured as a portable electronic device that interfaces locally or remotely (e.g., via wireless transmission).

In electronic device 1700, the processor 1702 may include central processing units (CPUs), graphics processing units (GPUs), programmable logic apparatuses, special purpose processor systems, microcontrollers or microprocessors. By way of example and not limitation, the processor may also include analog processors, digital processors, microprocessors, multi-core processors, processor arrays, network processors, and the like.

The processor 1702 may execute instructions or code stored in the memory 1701, which may also store data. Instructions and data may also be transmitted and received over a network via a network interface apparatus, which may employ any known transport protocol.

The memory 1701 may be integrated with the processor 1702, e.g., a RAM or flash memory is arranged within an integrated circuit microprocessor or the like. Additionally, the memory 1701 may include a separate apparatus such as an external disk drive, storage array, or any other storage device that may be used by a database system. The memory 1701 and the processor 1702 may be operatively coupled, or may communicate with each other, e.g., through I/O ports, network connections, etc., to enable the processor 1702 to read files stored in the memory.

In addition, the electronic device 1700 may also include a video display (such as a liquid crystal display) and a user interaction interface (such as a keyboard, mouse, touch input device, etc.). All components of electronic device 1700 may be connected to each other via a bus and/or network.

According to an exemplary embodiment of the present disclosure, there may also be provided a computer readable storage medium storing instructions, wherein the instructions, when run by at least one computing apparatus, cause the at least one computing apparatus to perform a computing task management method for a database as described above.

Examples of computer readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer may execute the computer programs. The instructions or computer programs in the computer readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner. It should be noted that the instructions may also be used to perform additional steps in addition to the steps described above or to perform more specific processing when performing the steps described above, and the content of these additional steps and further processing has already been referred to in the process of describing the relevant methods, and will therefore not be repeated herein in order to avoid repetition.

Another embodiment of the present disclosure involves a system including at least one computing apparatus and at least one storage apparatus storing instructions, wherein the instructions, when run by the at least one computing apparatus, cause the at least one computing apparatus to perform a computing task management method for a database as described above.

It should be noted that a system according to the exemplary embodiment of the present disclosure may rely entirely on operation of a computer program or instructions to implement the corresponding functions, i.e., the individual units correspond to the steps in the functional architecture of the computer program, such that the entire system is invoked to implement the corresponding functions by means of specialized software packages (e.g., libraries).

Any functional blocks and modules shown in the accompanying drawings and described above may be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System on chip (SoC), a programmable logic unit, a microprocessor, application-specific integrated circuit (ASIC), etc. Additionally or alternatively, these functional blocks and modules may be implemented by one or more software modules or algorithms saved in an internal memory of a corresponding device or an external memory, and may be executed by at least one processor of the corresponding device.

On the other hand, when the above system is implemented as software, firmware, middleware, or microcode, program code or code segments for performing the corresponding operations may be stored in a computer readable medium, such as a storage medium, such that at least one processor or at least one computing apparatus may perform corresponding operations by reading and running the corresponding program code or code segments.

According to an exemplary embodiment of the present disclosure, a storage apparatus may be integrated with a computing apparatus, e.g., RAM or a flash memory is deployed in an integrated circuit microprocessor, etc. In addition, the storage apparatus may include a separate apparatus, such as an external disk drive, a storage array, or any other storage apparatus that may be used by a database system. The storage apparatus and the computing apparatus may be operationally coupled or may communicate with each other, for example, via I/O ports, network connection, and the like, such that the computing apparatus is capable of reading instructions stored in the storage apparatus.

Another embodiment of the present disclosure involves a computer program product including a computer program/instruction, wherein the computer program/instruction, when run by a processor, may implement a computing task management method for a database as described above.

According to the computing task management method for a database, the apparatus, the electronic device, the storage medium, the system, and the computer program product of the present disclosure, the process near memory characteristics of the PNM device may be utilized to rebuild the computing architecture of the storage model such as RocksDB, in order to offload, from the CPU to the PNM device, the computing task involved in the data operation (such as the file compaction, the range query in the storage engine and the like) which requires frequent data replication and movement between the CPU and the memory just for the CPU to perform simple computations, thereby significantly reducing the amount of data read into the memory, reducing the burden on the memory, releasing the resource utilization of the CPU, and reducing the data interaction between the CPU and the memory, reducing the impact of a large number of data computations on the performance of the storage engine, and increasing the memory bandwidth. This in turn improves the execution performance and efficiency of the storage engine system.

In addition, the architecture system of the present disclosure may be a new function module added directly based on the CXL on the basis of the original design architecture of the storage engine such as RocksDB, to realize the hot-plugging function of the computing unit and memory expansion, such that it is possible to add/remove the CXL device online at the CXL server as needed without destroying the original system. Specifically, the process near memory characteristics of the CXL-PNM storage device may be utilized to offload the computing task of the file compaction and the range query in the storage engine from the CPU to the CXL-PNM device, to obtain an accelerated computing architecture of the present disclosure. The CXL-based process near memory scheme may substantially reduce the data interaction between the memory and the CPU in the storage engine and further improve the overall performance of the storage engine.

The above describes various exemplary embodiments of the present disclosure, and it should be understood that the above description is only exemplary and not exhaustive, and the present disclosure is not limited to the disclosed exemplary embodiments. Without departing from the scope and spirit of the present disclosure, many modifications and changes will be apparent to a person of ordinary skill in the art. Therefore, the scope of protection of the present disclosure should be based on the scope of the claims.

What is claimed is:

1. A computing task management method, wherein the method is executed by one or more processors and applied to a process near memory (PNM) device, and wherein the method comprises:
based on receiving an execution instruction associated with a preset computing task from a host, acquiring, from a storage of the host, data associated with execution of the preset computing task, wherein the preset computing task is a computing task that, when performed by the host, comprises data exchange between the storage and a central processing unit (CPU) with a frequency higher than a preset degree and configured for computing power lower than a preset computing power;
storing the data in a memory associated with the PNM device;
obtaining a computing result corresponding to the preset computing task based on performing the preset computing task using the data exchange performed with the memory associated with the PNM device; and
transmitting the computing result to the host.

2. The method of claim 1, wherein the preset computing task comprises a computing task associated with at least one of a range query for database space optimization or a file compaction for the database space optimization.

3. The method of claim 2, wherein, based on the preset computing task being the computing task associated with the file compaction, the acquiring the data associated with execution of the preset computing task comprises:
receiving, from the host, the execution instruction associated with the preset computing task based on the host detecting that a trigger condition for the file compaction has been reached, wherein the trigger condition comprises a threshold condition; and
acquiring the data associated with execution of the preset computing task from the memory of the host based on the execution instruction associated with the preset computing task.

4. The method of claim 2, wherein, based on the preset computing task being the computing task associated with the file compaction, the performing the preset computing task comprises:
determining a file to be compacted for the file compaction;
reading respective key-value pairs in the file to be compacted from the memory associated with the PNM device;
sorting the respective key-value pairs in a key order; and
obtaining a sorted sequence of key-value pairs in the memory associated with the PNM device.

5. The method of claim 2, wherein, based on the preset computing task being the computing task associated with the range query, the acquiring the data associated with execution of the preset computing task comprises:
receiving, from the host, the execution instruction associated with the preset computing task based on the host acknowledging a condition of the range query, wherein the condition of the range query comprises a start value and an end value of a query key; and
acquiring the data associated with execution of the preset computing task from the memory of the host based on the execution instruction associated with the preset computing task.

6. The method of claim 2, wherein, based on the preset computing task being the computing task associated with the range query, the performing the preset computing task comprises:
reading a memory table from the memory associated with the PNM device;
traversing key-value pairs in the memory table, wherein, when a condition of the range query is not fully covered by the memory table, the traversing comprises reading, through a Bloom filter, an ordered string table that satisfies the condition of the range query from the storage to the memory associated with the PNM device; and
collecting, from the memory table and the ordered string table, all key-value pairs that satisfy the condition of the range query.

7. An apparatus for computing task management in a database, the apparatus being applied to a process near memory (PNM) device, the apparatus comprising:
a data acquisition processor configured to:
based on receiving an execution instruction associated with a preset computing task from a host, acquire, from a storage of the host, data associated with execution of the preset computing task, wherein the preset computing task is a computing task that, when performed by the host, comprises data exchange between the storage and a CPU with a frequency higher than a preset degree and configured for computing power lower than a preset computing power;
store the data in a memory associated with the PNM device;
a task executor configured to obtain a computing result corresponding to the preset computing task based on performing the preset computing task using the data exchange performed with the memory associated with the PNM device; and
a computing result transmitter configured to transmit the computing result to the host.

8. The apparatus of claim 7, wherein the preset computing task comprises a computing task associated with at least one of a range query for database space optimization or a file compaction for the database space optimization.

9. The apparatus of claim 8, wherein, based on the preset computing task being the computing task associated with the file compaction, the data acquisition processor is configured to perform, for the acquiring the data associated with execution of the preset computing task comprises:
receiving, from the host, the execution instruction associated with the preset computing task based on the host detecting that a trigger condition for the file compaction has been reached, wherein the trigger condition comprises a threshold condition; and
acquiring the data associated with execution of the preset computing task from the memory of the host based on the execution instruction associated with the preset computing task.

10. The apparatus of claim 8, wherein, based on the preset computing task being the computing task associated with the file compaction, the performing the preset computing task comprises:
determining a file to be compacted for the file compaction;
reading respective key-value pairs in the file to be compacted from the memory associated with the PNM device;
sorting the respective key-value pairs in a key order; and
obtaining a sorted sequence of key-value pairs in the memory associated with the PNM device.

11. The apparatus of claim 8, wherein, based on the preset computing task being the computing task associated with the range query, the acquiring the data associated with execution of the preset computing task comprises:
receiving, from the host, the execution instruction associated with the preset computing task based on the host acknowledging a condition of the range query, wherein the condition of the range query comprises a start value and an end value of a query key; and
acquiring the data associated with execution of the preset computing task from the memory of the host based on the execution instruction associated with the preset computing task.

12. The apparatus of claim 8, wherein, based on the preset computing task being the computing task associated with the range query, the performing the preset computing task comprises:
reading a memory table from the memory associated with the PNM device;
traversing key-value pairs in the memory table, wherein, when a condition of the range query is not fully covered by the memory table, the traversing comprises reading, through a Bloom filter, an ordered string table that satisfies the condition of the range query from the storage to the memory associated with the PNM device; and
collecting, from the memory table and the ordered string table, all key-value pairs that satisfy the condition of the range query.

13. A system for computing task management in a database, wherein the system comprises a host and a process near memory (PNM) device, wherein:
the host is configured to:
transmit an execution instruction associated with a preset computing task to the PNM device; and
receive a computing result transmitted by the PNM device; and
the PNM device is configured to:
based on receiving the execution instruction associated with the preset computing task from the host, acquire, from a storage of the host, data associated with execution of the preset computing task, and store the data in a memory associated with the device, wherein the preset computing task is a computing task that, when performed by the host, comprises data exchange between the storage and a CPU with a frequency higher than a preset degree and configured for computing power lower than a preset computing power;
perform the preset computing task using the data exchange performed with the memory associated with the PNM device to obtain the computing result corresponding to the preset computing task; and
transmit the computing result to the host.

14. The system of claim 13, wherein the preset computing task comprises a computing task associated with at least one of a range query for database space optimization or a file compaction for the database space optimization.

15. The system of claim 14, wherein, based on the preset computing task being the computing task associated with the file compaction, the acquiring the data associated with execution of the preset computing task comprises:
receiving, from the host, the execution instruction associated with the preset computing task based on the host detecting that a trigger condition for the file compaction has been reached, wherein the trigger condition comprises a threshold condition; and
acquiring the data associated with execution of the preset computing task from the memory of the host based on the execution instruction associated with the preset computing task.

16. The system of claim 14, wherein, based on the preset computing task being the computing task associated with the file compaction, the performing the preset computing task comprises:
determining a file to be compacted for the file compaction;
reading respective key-value pairs in the file to be compacted from the memory associated with the PNM device;
sorting the respective key-value pairs in a key order; and
obtaining a sorted sequence of key-value pairs in the memory associated with the PNM device.

17. The system of claim 14, wherein, based on the preset computing task being the computing task associated with the range query, the acquiring the data associated with execution of the preset computing task comprises:
receiving, from the host, the execution instruction associated with the preset computing task based on the host acknowledging a condition of the range query, wherein the condition of the range query comprises a start value and an end value of a query key; and
acquiring the data associated with execution of the preset computing task from the memory of the host based on the execution instruction associated with the preset computing task.

18. The system of claim 14, wherein, based on the preset computing task being the computing task associated with the range query, the performing the preset computing task comprises:
reading a memory table from the memory associated with the PNM device;
traversing key-value pairs in the memory table, wherein, when a condition of the range query is not fully covered by the memory table, the traversing comprises reading, through a Bloom filter, an ordered string table that satisfies the condition of the range query from the storage to the memory associated with the PNM device; and
collecting, from the memory table and the ordered string table, all key-value pairs that satisfy the condition of the range query.
